(19) United States
(12) Patent Application Publication
(10) Pub. No.: US 2008/0243599 A1
(43) Pub. Date: Oct. 2, 2008

(54) Rapid notarization method and system

(76) Inventor: Dusic Kwak, Lorton, VA (US)

Correspondence Address: MAIER & MAIER, PLLC, 1000 DUKE STREET, ALEXANDRIA, VA, 22314, US

(21) Appl. No.: 11/898,878

(22) Filed: Sep. 17, 2007

Related U.S. Application Data
(63) Continuation-in-part of application No. 11/727,292, filed on Mar. 26, 2007.

(51) Int. Cl. G07C 13/00; G06F 17/00; G06Q 10/00; G06F 19/00; G06F 11/00

(52) U.S. Cl. 705/12

(57) ABSTRACT

A method and system for voting are disclosed. The method and system can include a voting terminal that may display an electronic ballot. The electronic ballot may contain some voting data and a voter may input voting or selection data into the electronic ballot using a computer peripheral device. A copy of the electronic ballot may be printed and a voter may substantially simultaneously sign the printed copy of the ballot and the electronic copy of the ballot.

### CROSS REFERENCE TO RELATED APPLICATION

This application is a continuation in part of and claims priority to U.S. patent application Ser. No. 11/727,292, entitled RAPID NOTARIZATION METHOD AND SYSTEM and filed Mar. 26, 2007, the entire contents of which are hereby incorporated by reference.

### BACKGROUND

The background for this application relates generally to the signing and notarization of documents. If a person desires to have another person sign a document and then have the document notarized, a physical copy of the notarized document must at least be sent from the signing and notarizing parties to the original person. This process can take a significant amount of time. For example, if a person has a document in Washington, D.C. that they need to have signed and notarized in Los Angeles, Calif., a variety of time-consuming and often expensive steps must be taken.

In this example, a copy of the original document to be signed and notarized may be electronically transmitted from Washington to Los Angeles, such as using electronic mail (email) or facsimile (fax). This process typically does not require a significant time or money investment. However, after a physical copy of the document is presented to the party who is to sign the document, they must sign the document in the presence a properly licensed notary. The notary may then also sign the document. Next, the notary may apply their seal, which often involves creating an imprint on the document that can not be reproduced through traditional means, such as photocopying. However, after the notary applies their seal and signs the document, the physical document must then be transported back to the original party.

In order to transport the document to the original party, any of a variety of shipping techniques may be utilized. Examples include traditional mail, shipping companies and couriers. However each of these manners of returning the document to the original party may take a significant amount of time, usually not fewer than twenty four hours. Additionally, shipping can cost a significant amount of money and the amount of money typically increases based upon the quickness with which a party desires their shipment to be made. Therefore, it may be desirable to offer a system that would allow a person to obtain a signed, notarized document from great distances with very little time or money expended.

### SUMMARY OF THE INVENTION

An embodiment of the invention can include a method for voting. The method for voting can include the steps of displaying a ballot with voting data into a voting terminal as well as inputting selection data into the voting terminal. The method for voting may further include printing the ballot with the selection data and signing the ballot physically and electronically substantially simultaneously with a computer peripheral device. Further, in some exemplary embodiments, the method for voting may have the steps of transmitting an electronically signed ballot to an electronic storage device and depositing a physically signed ballot in a containment unit.

Another exemplary embodiment may include a system for voting. The system can include any of a variety of components, such as a voting terminal, an electronic ballot displayed on the voting terminal, a computer peripheral device and a printer. In this exemplary embodiment, the voter may view the electronic ballot displayed on the voting terminal and may vote with inputs from the computer peripheral device to the voting terminal. The voting terminal may then generate an electronic copy of the ballot that may shows the votes of the voter. The printer may then print a hard copy of the ballot that may shows the votes of the voter. Also, in some examples, the voter may substantially simultaneously electronically sign the electronic copy of the ballot, which may create an electronically signed ballot and may physically sign the hard copy of the ballot, which may create a physically signed ballot.

Another exemplary embodiment of the invention includes a system for voting at a remote location. This system may include means for having an electronic ballot, means for displaying the electronic ballot and means for inputting voting data into the electronic ballot. The system may also have means for printing the electronic ballot as well as means for signing a hard copy of the electronic ballot and the electronic ballot substantially simultaneously. Further embodiments of the system include means for transmitting a copy of a signed electronic ballot to a remote location, means for storing the hard copy of the ballot after it is signed and means for counting a plurality of ballots.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a method and system for obtaining a signature and notarization.

FIG. 2 is an exemplary diagram showing a method and system for obtaining a signature and notarization.

FIG. 3 is an exemplary diagram showing a method and system for voting.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention,” “alternative embodiment(s),” and “exemplary embodiment(s)” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Additionally, some exemplary embodiments include network adapters that may also be coupled to the system to enable the data processing system to become coupled to other data processing systems or remote printers or storage devices through intervening private or public networks. Modems, cable modems and Ethernet cards are just a few of the currently available types of network adapters.

Also, exemplary embodiments may include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

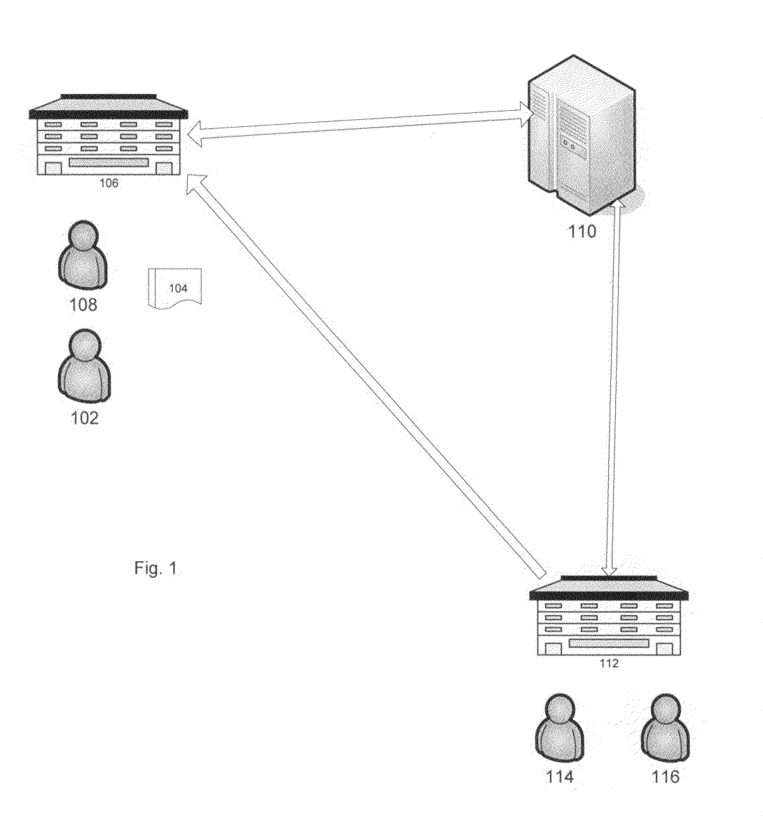

In one exemplary embodiment, as shown in FIG. 1, a document sent by a first party may be signed by a second party, notarized and returned to the first party in a short amount of time. In this embodiment, a transmission and notarization system 100 can allow a first party 102 to transmit a document 104 from a local location 106 to a remote location 112 and back to the local location 106 in a short amount of time. For example, first party 102 may have document 104 that may be needed or desired to be signed and notarized. The second party 114 who may need to sign document 104 may be located at a significant physical distance from first party 102, which could typically cause a significant amount of time to expire between the time when first party 102 needs or desires to have document 104 signed and notarized. Thus, in one exemplary embodiment, first party 102 may make an electronic copy or scanned version of document 104. The electronic copy of document 104 may then be uploaded to a central database 110 at either the first party's 102 home or any other location local to first party 102. For example, first party 102 may log into a website or any other online portal, for example by entering a user name and password. The website may have an access fee or membership fee that first party 102 may have to pay before he or she accesses the website or before he or she transmits any data. Additionally, the website may be maintained by any entity, for example the United States Post Office or any other shipping or transmitting agent, such as Federal Express, United Parcel Service or the like. Alternatively, the website could be maintained by any business or association having a variety of branch locations in a variety of different locales.

In a further exemplary embodiment, before, during or after uploading document 104, first party 102 may enter any desired transmission data that he or she desires. For example, first party 102 may enter any desired contact information for second party 114, such as their address, phone number and email address. Additionally, first party 102 may enter the desired actions that they wish to happen, for example the transmission of document 104, the signing and notarization of document 104 by second party 114 and remote agent 116, respectively, and the return of the signed and notarized document 104 to first party 102.

After the electronic copy of document 104 is uploaded to a database, the document 104 may be accessed and/or transmitted. In one exemplary embodiment, the electronic copy of the document may be accessed, for example on a secure network, by a local agent 108 at a local location 106. Local location 106 may be a branch of the same entity that maintains the website or online portal described above, such as the United States Post Office, any other type of post office or any other shipping or transmitting agent, such as Federal Express or United Parcel Service. Alternatively, local location could be any business or service with a variety of branches, such as a bank or convenience stores, for example 7-11. Local agent 108 may review the electronic copy of document 104 or otherwise access the electronic copy of the document 104 at local location 106 in order to determine that it is in proper condition for transmittal to remote location 112, which may also be a branch of the entity described above, such as the United States Post Office, any other type of post office or any other shipping or transmitting agent.

After it is determined that document 104 is in the appropriate condition for transmittal, document 104 may be transmitted from central database 110 to remote location 112. Remote location 112 will be a location that is physically proximate second party 114 or is otherwise at a desired location that is accessible to second party 114. Remote location 112 may be determined based upon information that first party 102 inputted before, during or after uploading document 104 to central database 110 or may be information that first party 102 otherwise provides to local agent 108. Before, during or after document 104 is transmitted from central database 110 to remote location 112, second party 114 may receive notification that their presence is desired at remote location 112. For example, using the information first party 102 may have entered before, during or after uploading document 104 to central database 110 or using information provided to local agent 108, an email, phone call, facsimile or any other manner of providing notification known to one having ordinary skill in the art may be used to contact second party 114. This notification can provide second party 114 with information saying, for example, that their presence is desired at remote location 112 for the purpose of signing and notarizing document 104.

Upon receipt of the notification, second party 114 may travel to remote location 112. In one exemplary embodiment, upon the arrival of second party 114 to remote location 112, document 104 may be displayed to second party 114 and remote agent 116. However, in order to view document 104, second party may have to present some form of identification, such as a driver's license, and/or some other type of information, such as a confirmation number or password that could be found in the notification, to remote agent 116. Document 104 may be displayed in any manner, for example electronically on a display or printed and physically shown on paper. Second party 114 may then review document 104 as desired. After reviewing document 104, second party 114 may then sign document 104. The signing of document 104 may take place electronically, for example through the use of a stylus and a touch pad or electronic signature block, or in any other manner known by one having ordinary skill in the art, with the signature of second party 114 being electronically imprinted on document 104, as is also known in the art. Remote agent 116, who may also be a notary, may witness the signing of document 104 by second party 114. In his or her capacity as a notary, remote agent 116 may then electronically affix their notary seal to document 104. The affixing of the notary seal by the second party 114 can be done in any of a variety of manners which will be discussed in more detail below with respect to additional exemplary embodiments. Remote agent 116 may then electronically sign document 104 as a final act of being a witness to the signing of second party 114.

After document 104 has been signed by both second party 114 and signed and notarized by remote agent 116, it may be transmitted, via central database 110, to local location 106. At local location 106, document 104, including the signature of second party 114 and the signature and notary seal of remote agent 116 may be printed. After document 104 has printed, local agent 108 may review the signatures and seal and affix his own signature. The signature of local agent 108 may be accompanied by a statement on document 104, such as an attestation statement, indicating that the signature of second party 114 was witnessed by remote agent 116 and that the signature and seal of remote agent 116 were appropriately affixed and transmitted according to standard practices. The printed document 104, with the appropriate, desired or necessary signatures, seal and statement or statements may then be returned to first party 102. Thus, in this exemplary embodiment, document 104 may be signed and notarized by the appropriate parties in a short amount of time and without the need to ship a physical document to a remote location. Additionally, if second party 114 responds to the notification and proceeds to remote location 112 in a short amount of time, document 104 may be signed, notarized and returned to first party 102 in a very short amount of time, for example less than an hour.

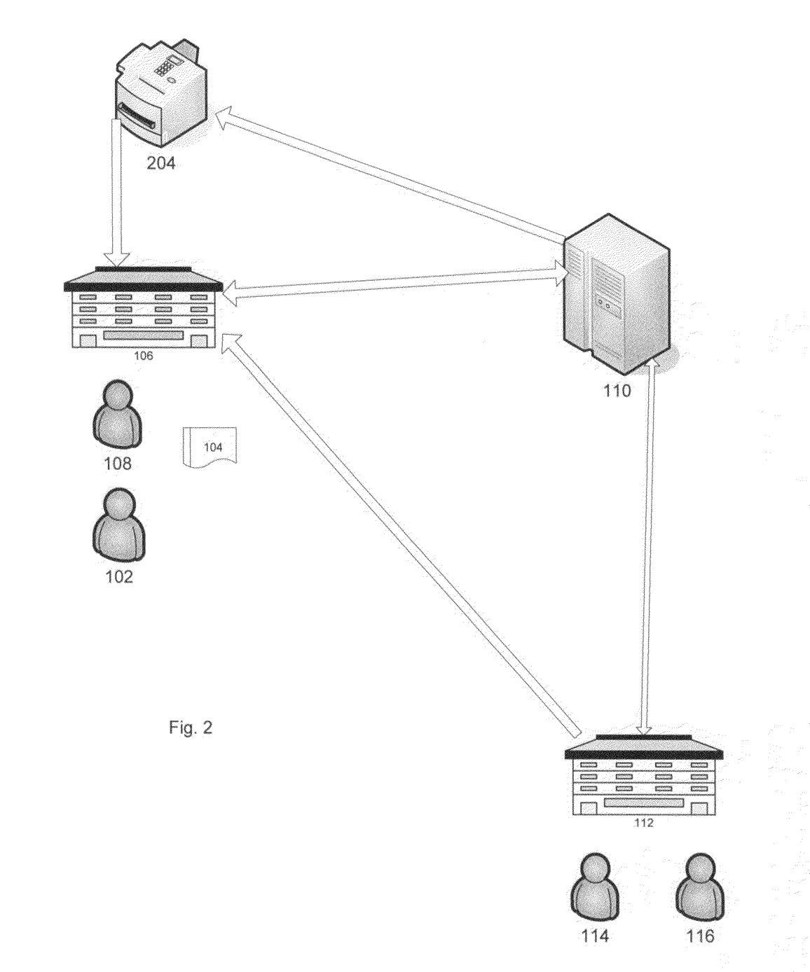

In another exemplary embodiment, as shown in FIG. 2, a first party may again have a document notarized in rapid fashion. However, in this embodiment, the physical application of the signature of a second party and the application of a signature and a seal by remote agent may all be performed in a single, local location. Here, similar to the exemplary embodiment described above, first party 102 may upload document 104 that is desired to be signed and/or notarized. Document 104 may again be uploaded to central database 110. Alternatively, first party 102 may also bring document 104 to local location 106 where document 104 may be scanned and entered into central database 110.

Further, in this exemplary embodiment, after document 104 is deemed appropriate to be transmitted and after a notification is sent to second party 114, second party 114 may travel to remote location 112. At remote location 112, remote agent 116, who may again be a notary, may be present to provide second party 114 with access to document 104 following the presentation of the appropriate identification and/or information by second party 114 to remote agent 116.

After second party 114 reviews document 104, second party 114 will again proceed to sign his or her signature with a stylus in an electronic signature block. However, in this exemplary embodiment, the movement of the stylus on the touchpad or signature block may be recorded by an associated computer that is capable of recording and storing the motions of the stylus on the signature block. The stored motions may then be transmitted, for example in real time or as soon as they are recorded and stored, via a secure connection, such as through a secure intranet or network, to printing mechanism 204. Printing mechanism 204 may be any type of printing mechanism, for example a computer printer or a mechanized arm capable of holding a pen and recreating human handwriting, while also having the ability to imprint seals and stamps. Printing mechanism 204 can have attached thereto a physical copy of document 104 onto which it may print or write data. Additionally, the printing mechanism 204 may be physically located at local location 106, and may be in the physical presence of local agent 104. The stored motions of the signature may then be replicated by the printer or robotic mechanism using standard printing known to one having ordinary skill in the art. Therefore the physical signature of the second party 114 may be physically applied by printing mechanism 204 in the presence of first party 102 and local agent 104.

Remote agent 116 may then apply his or her notary seal to document 104. Because notary seals may require impressions to be made to a document in addition to any ink that may be used, any of a variety of techniques may be used in order for an appropriate seal to be placed on document 104. For example, a seal could be pressed against a signature box and the contours of the seal could be, similar to the above, recorded, stored and transmitted to the printing mechanism 204. Printing mechanism 204 could include one or more mechanical devices capable of replicating the necessary indent and/or ink created by a notary seal. Printing mechanism 204 could also have access to a database of notary seals that could be used in the recreation of seals on a physical document. Alternatively, document 104 could be automatically passed, for example using a conveyor system, through a press that includes a plurality of notary seals. The appropriate notary seal could then be placed on document 104. Document 104 could then be automatically replaced in printing mechanism 204 for the addition of any other desired signatures.

After document 104 is replaced and, similar to the above, when remote agent 116 is to sign document 104, they may use a stylus and touchpad or signature box. The movements of the stylus may then be recorded, stored and transmitted to printing mechanism 204 so that the signature may be written on document 104. In a further exemplary embodiment, document 104 may be attested and signed by local agent 108, thereby verifying that appropriate procedures were performed. Document 104, with the appropriate, desired or necessary signatures, seal and statement or statements may then be returned to first party 102.

Thus, in this exemplary embodiment, a document may be signed by second party 114 and notarized and signed by remote agent 116 without the need for a physical document to be shipped to remote location 112 and returned to local location 106. Additionally, the physical signing application of the signature of second party 114 and the notary seal and signature of remote agent 116 will be performed by printing mechanism 204 on a physical copy of document 104 while in the presence of first party 102 and local agent 104.

Still other applications of the method and system disclosed herein may be utilized. For example, many high schools, colleges and graduate schools accept applications online. Using the above system and method, a school official, similar to first party 102, may receive an application from an applicant, similar to second party 114. The school official may then send a notification to the applicant desiring for them to sign or provide other indication that the application is legitimate or that the applicant intends to matriculate at that particular school. The applicant could then provide a real-time signature to the school official.

In yet another exemplary embodiment, an individual's tax returns could be notarized at the time of submission, for example to indicate that the document was signed and submitted by the proper person. In still another exemplary embodiment, online retailers could utilize the system and method to verify the identity of individuals who purchase their products online. This could be used as a manner of decreasing credit card fraud, identity theft and other types of fraud that are prevalent online. For example, an online retailer could receive a service or product order from an online customer. Then, similar to the above exemplary embodiments, the online retailer could send a notification to the online customer requesting a signature. The online customer could then proceed to a location, such as local location 106, where they could provide identification to a local agent 108 a signature in any of the manners described herein.

In still another exemplary embodiment, any of the above described methods and systems may be used in conjunction with a voting system. For example, absentee ballots are currently mailed, emailed and faxed in by thousands of citizens in the United States and other countries during each election. The absentee ballots may contain an oath and signature, but the identity of the party submitting the ballot is seldom confirmed. Therefore, at a time when a person is to submit a ballot, for example online, they may electronically submit the ballot to the appropriate collection party. The collection party may then provide the person submitting the ballot with a notification to verify their identity. The person submitting the ballot may then travel to the appropriate location, such as local location 106, where they can provide identification to a local agent 108 and provide a signature in any of the manners described above.

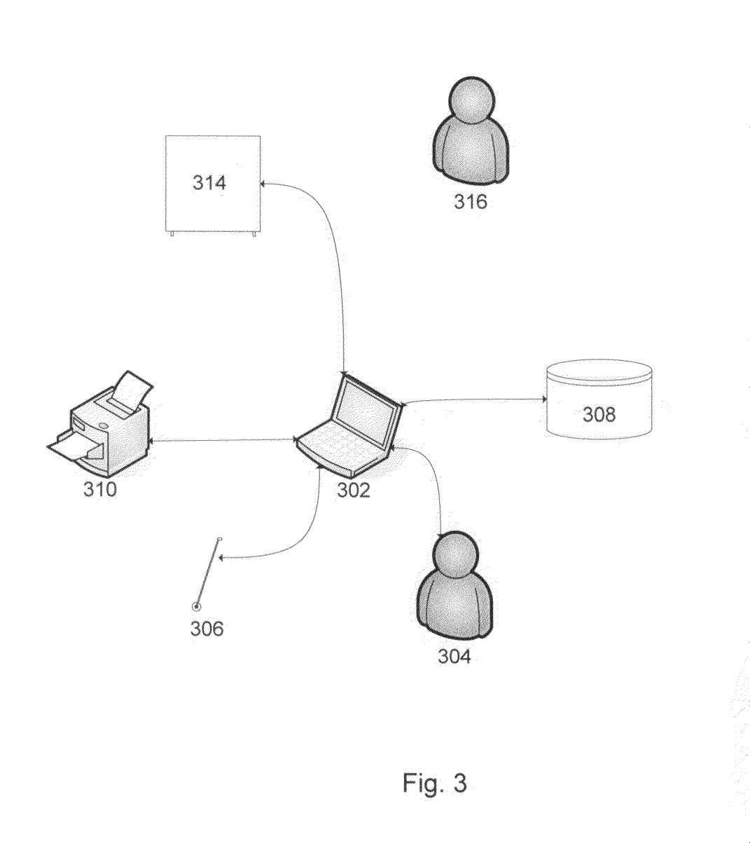

In yet another exemplary embodiment, as shown in FIG. 3, a method and system for voting or balloting may be shown. In this exemplary embodiment, a voting terminal 302, such as a wired or wireless terminal, may be disposed in a location used for voting or balloting. The voting or balloting location may be any location used for any type of voting or balloting. Further, the election or vote for which the voting or balloting location is being used may be any type of election or vote, for example federal or state elections or votes, school elections or votes, corporate elections or votes or any other type of election or vote. Also, the voting terminal 302 may be any type of voting terminal known to one having ordinary skill in the art, for example a wired or wireless desktop or laptop computer. Additionally, the voting terminal 302 may be disposed at any of a variety of locations. In some exemplary embodiments, the voting terminal 302 may be disposed at a location having a large number of absentee voters, for example at military bases located domestically and abroad, or embassies. One or more voting terminals 302 may also be located in environments where a voting population may be dispersed in a wide variety of locations, for example in corporate environments having a variety of offices in a variety of different locations. Other locations may include schools and universities that have elections, for example student government elections, and post offices, which may act to service voters located remotely from their home voting precinct. In still further exemplary embodiments, the voting terminal 302 may be easily transportable so as to allow the voting terminal 302 to be quickly and easily set up in any desired location. Similarly, the voting terminal 302 may be quickly and easily removed from a first location to be set up in a second location or any other desired location.

In a further exemplary embodiment, a user, such as a voter 304, may place an appropriate number of votes or vote for his or her desired choices in a vote or an election, depending on the type of election or vote that may be taking place, on the voting terminal 302. The voting terminal 302 may have a display, such as any display known to one having ordinary skill in the art, which may show or display any voting data, such as options or instructions, as well as the names of candidates or issues that may be voted for. The voting may include any number of votes for any number of candidates, issues or other items to be voted upon. The votes may also be of any nature, for example elections to office, votes on issues, corporate voting or school voting, as well as any other type of voting or election known to one having ordinary skill in the art. Votes may be cast by voter 304 in any of a variety of manners, for example highlighting a desired option, checking a box, clicking a radio button or clicking on a desired option. Any selection, checking or clicking may be performed using any type of computer peripheral device 306, for example a mouse, stylus, Wowpen™ or any other computer peripheral device known to one having ordinary skill in the art. In still further exemplary embodiments, voting terminal 302 may have a display that may also function as a touch screen. Thus, in this exemplary embodiment, the voter 304 may select a desired option to vote for by touching the screen in an appropriate location.

After the voter 304 has made the desired or appropriate number of votes, voting data, choices, choice data, selections or selection data, the voting terminal 302 may display a completed ballot. The completed ballot may include the name or type of the election or elections and vote or votes and may also include the selections or choices made by voter 304. The voter 304 may then be given an opportunity to review his or her selections on the ballot before finalizing and submitting the ballot.

In a one exemplary embodiment, when the voter 304 finalizes and submits the ballot, he or she may sign the ballot. The voter 304 may sign the ballot in any of a variety of manners. For example, the voter 304 may sign the ballot electronically using computer peripheral device 306. As described previously, computer peripheral device 306 may be a device such as a stylus or a Wowpen™. A stylus may allow the voter 304 to electronically sign the ballot using the stylus and a touchpad or signature pad. The electronic signature may then appear on the ballot, similar to a signature made using a pen and paper. Similarly, the voter 304 may sign the ballot using a Wowpen™ or similar computer peripheral device 306. This type of device may be a device that may act similar to a vertically-oriented computer mouse or a mouse having pen-like or pencil-like qualities and may allow the voter 304 to electronically sign the ballot without the use of any other components.

After the ballot is electronically signed, the ballot may be sent to hard drive 308, where an electronic version of the ballot may be stored. The hard drive 308 may be any type of hard drive or electronic storage device and may be connected to the voting terminal 302 in any manner known to one having ordinary skill in the art, for example a wired or wireless connection. Ballots stored on hard drive 308 may be counted or tabulated by any manner known to one having ordinary skill in the art. Also, in some exemplary embodiments, hard drive 308 may be relocated to a location remote from the voting terminal 302, and any data stored on hard drive 308 may be secured, stored or tabulated, as described previously. In still other exemplary embodiments, the ballots or other data stored on hard drive 308 may be transmitted, for example using wired or wireless transmission, to a server 312. The server 312 may be located remotely from either or both of the voting terminal 302 and the hard drive 308. Additionally, after the ballots or other data are transmitted to the server 312, the data may be secured, stored or tabulated in any manner known to one having ordinary skill in the art.

In a further exemplary embodiment, after the voter 304 has finalized his or her ballot, which may or may not include electronically signing the ballot, the completed ballot may be printed, for example by printer 310. The printer 310 may be any type of printer and may be communicatively coupled with the voting terminal 302 in any manner known to one having ordinary skill in the art, for example through a wired or wireless connection. In some exemplary embodiments, the printer 310 may print a copy of a ballot having an electronic signature, which may be added to the ballot through any of the exemplary embodiments described herein. The voter 304 may have an opportunity to view the printed ballot and may then deposit the printed ballot in containment unit 314. Containment unit 314 may be a safe, lock box, bulk envelope, singular envelop, or any other known containment unit, shipping unit or combination thereof known to one having ordinary skill in the art. Following a vote or election, any printed ballots in containment unit 314 or any other containment or shipping unit may be counted or tabulated in any manner known to one having ordinary skill in the art.

In a different exemplary embodiment, the voter 304 may finalize his or her ballot and print it without an electronic signature. In this exemplary embodiment, a signature may then be added to the ballot, for example using the computer peripheral device 306, which may also be a variation of the Wowpen™. Here, the computer peripheral device 306 may have known computer mouse and stylus functionality. Further, the computer peripheral device 306 may include traditional ink pen writing capabilities. Thus, the voter 304 may physically sign the printed ballot using ink associated with the computer peripheral device 306 while, simultaneously or substantially simultaneously, also transmitting his or her signature, in electronic format, to the electronic ballot or an appropriate electronic signature area that is displayed on the voting terminal 302. Then, similar to the above-described embodiments, an electronically signed copy of the ballot may be transmitted to the hard drive 308 and a printed copy of the ballot having an ink signature may be deposited in the containment unit.

In a further exemplary embodiment, an official 316 may be present while the voter 304 is voting using the voting terminal 302. The official 316 may be any person, for example a federal or state election official, a school representative, a corporate representative or any other person, such as a notary. The official 316 may not view the votes or selections made by voter 304, but the official may be present to answer any questions the voter 304 may have or to otherwise assist the voter in any way or to provide any desired or necessary technical assistance or repairs to the voting terminal 302 or any of its networked components. Additionally, the official 316 may serve as a notary, which may allow a printed ballot that is signed in the presence of the official 316 to be notarized.

In yet another exemplary embodiment, the voting terminal 302 may be a computer or other networked device owned by the voter 304. In this exemplary embodiment, the voter 304 may log onto a secure website or other website allowing voting. In some embodiments, the voter 304 may have to provide some type of identification or verification information to access the secure website. The voter 304 may then access a desired or appropriate ballot and place his or her votes. The voter 304 may then finalize his or her ballot electronically. In some exemplary embodiments, the voter may have a computer peripheral device 306 similar to a Wowpen™ or stylus that may be used with their computer. Thus, the voter 304 may electronically sign the ballot. The electronically signed ballot may be transmitted to any of a variety of locations for tabulation and storage, for example hard drive 308 or server 312. Additionally, a printed copy of the ballot may be printed at a location proximate the official 316. This printed copy of the ballot may then be placed in containment unit 314, as described previously. The voter 304 may further be able to print a copy of the electronic ballot for his or her records or to mail to an appropriate official, agency or governing body as a hard copy of their ballot.

In some other exemplary embodiments, the voter 304 may be able to print and sign a ballot using ink. In one exemplary embodiment, the voter 304 may use a computer peripheral device 306 similar to the Wowpen™ with ink, as described above. In other exemplary embodiments, the voter may print out a completed version of his or her ballot and then sign it using a traditional pen. In this embodiment, the signed version of the ballot may be placed in the mail and sent to an appropriate official, agency or governing body as a hard copy of their ballot for tabulation. However, in this exemplary embodiment, an electronic copy of the ballot may also be transmitted to any location, for example hard drive 308, printer 310 or server 312 and may act to serve as a backup or record of a vote taking place in case a mailed version of the ballot is lost.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for voting, comprising:
displaying a ballot with voting data into a voting terminal;
inputting selection data into the voting terminal;
printing the ballot with the voting data and the selection data;
signing the ballot physically and electronically substantially simultaneously with a computer peripheral device;
transmitting an electronically signed ballot to an electronic storage device; and
depositing a physically signed ballot in a containment unit.

2. The method of claim 1, further comprising:
tabulating a plurality of physically signed ballots in the containment unit.

3. The method of claim 1, further comprising:
tabulating a plurality of electronically signed ballots in the electronic storage device.

4. The method of claim 1, wherein the electronic storage device is a hard drive.

5. The method of claim 4, further comprising:
transmitting a plurality of electronically signed ballots from the hard drive to a remotely located server.

6. The method of claim 1, wherein the ballot is an absentee ballot.

7. The method of claim 1, wherein the voting terminal is a computer.

8. The method of claim 7, wherein the computer is a laptop computer.

9. The method of claim 1, further comprising:
notarizing the physically signed ballot.

10. The method of claim 1, wherein the computer peripheral device is a combination mouse and writing pen.

11. The method of claim 1, wherein the computer peripheral device is a combination stylus and writing pen.

12. A system for voting, comprising:
a voter;
a voting terminal;
an electronic ballot displayed on the voting terminal;
a computer peripheral device; and
a printer;
wherein the voter views the electronic ballot displayed on the voting terminal and votes with inputs generated by the computer peripheral device and transmitted to the voting terminal, the voting terminal generates an electronic copy of the ballot that shows the votes of the voter, the printer prints a hard copy of the ballot that shows the votes of the voter, and the voter substantially simultaneously electronically signs the electronic copy of the ballot to create an electronically signed ballot and physically signs the hard copy of the ballot to create a physically signed ballot.

13. The system of claim 12, further comprising:
a hard drive that stores the electronically signed ballot.

14. The system of claim 13, further comprising:
a server that receives a copy of the electronically signed ballot from the hard drive.

15. The system of claim 12, further comprising:
a container that receives the physically signed ballot.

16. The system of claim 12, wherein the voting terminal is a portable computer.

17. The system of claim 12, wherein the ballot is an absentee ballot.

18. The system of claim 12, wherein the computer peripheral device is a computer peripheral device with an integrated ink pen.

19. The system of claim 12, wherein the computer peripheral device is a stylus with an integrated ink pen.

20. A system for voting at a remote location, comprising:
means for having an electronic ballot;
means for displaying the electronic ballot;
means for inputting voting data into the electronic ballot;
means for printing the electronic ballot;
means for signing a hard copy of the electronic ballot and the electronic ballot substantially simultaneously;
means for transmitting a copy of a signed electronic ballot to a remote location;
means for storing the hard copy of the ballot after it is signed; and
means for counting a plurality of ballots.
